(19) United States
(12) Patent Application Publication
(10) Pub. No.: US 2024/0275869 A1
(43) Pub. Date: Aug. 15, 2024

(54) Method for Optimizing Cloud Services Usage and Routing Among Cloud Provider Systems

(71) Applicant: Attimis Corporation, Sunnyvale, CA (US)

(72) Inventors: Leon Rishniw, San Francisco, CA (US); Georgiy Yakovlev, Pacifica, CA (US); Domenico Guardini, San Jose, CA (US); Damian Kowalewski, Sunnyvale, CA (US)

(21) Appl. No.: 18/421,280

(22) Filed: Jan. 24, 2024

Related U.S. Application Data
(60) Provisional application No. 63/485,222, filed on Feb. 15, 2023.

(51) Int. Cl. H04L 67/63; H04L 12/14; H04L 67/1097

(52) U.S. Cl. CPC H04L 67/63; H04L 12/1421; H04L 67/1097

(57) ABSTRACT

A computer system might comprise a requester computer that requests data from a remote storage service using a data request and an intermediate request router that analyzes the data request using a burden calculator and selects a selected storage provider based on results of a burden calculation. The burden calculation might include egress fees, quota limits, and/or geographic region indicators. The burden calculator might include a rules-based module that applies rules to burden components and wherein the burden calculator includes a machine-learning module that determines burden components based on behavioral patterns and/or probabilistic predictions. The behavioral patterns might include one or more of regular access peaks, adaptive latency measures, throughput measures, and/or data transfer size price adjustments.

### CROSS-REFERENCES TO PRIORITY AND RELATED APPLICATIONS

This application claims the priority benefit under 35 U.S.C. §119(e) of U.S. Provisional Patent Application No. 63/485,222, filed Feb. 15, 2023, hereby incorporated by reference in its entirety as though fully set forth herein.

### FIELD

The present disclosure generally relates to digital content transfer protocols and more particularly to optimization of content retrieval from various systems maintained by providers of cloud services.

### BACKGROUND

Cloud data storage and remote processing are services provided by many cloud computing providers. Data storage can come in several forms, such as object storage, blob storage, structured data storage, etc. Typically, data is stored within a cloud server's system and that cloud server's system provides for particular provider-specific protocols to upload, manage, and retrieve content. Different providers of cloud services might have different, provider-protocols for object storage that are often not cross-compatible with other providers of cloud services.

In a client-server configuration, a user's client will talk with a cloud data server using some cloud storage protocol to retrieve or manage the content stored in a given cloud data service infrastructure. The protocols might only allow direct communication with one specific cloud storage provider for any data transaction. In many cases, this results in single cloud provider implementations for data storage. Costs and agreements with some cloud providers might result in a user deploying only on one cloud provider's infrastructure.

Cloud data storage providers might implement some form of egress penalty for data.

These penalties might include data traffic-based charges, bandwidth capacity limits, added latency, throughput limits, measures of reliability, etc. These can result in considerable economic, technical, and/or logistical burdens on users. The storage costs associated with data management and access can increase as data volumes increase, and users might require redundancy in order to meet business continuity requirements. That redundancy might come with penalties. For example, a company might seek to migrate or replicate data to a secondary cloud data provider for cost or durability reasons, but the burdens might become prohibitively high in financial costs, resourcing needs, and time commitments.

Implementing multiple cloud data storage providers can be complicated and require intelligent selection of an optimal data source from available providers based on multiple factors, including, but not limited to, cost, performance, network limits, geographical restrictions, and availability. Without an ability to consider factors and make a dynamic decision for each client request, the ability to manage cost and reliable data access cannot be easily managed, which can result in unnecessary financial costs and business continuity issues.

### SUMMARY

A computer system might comprise a requester computer that requests data from a remote storage service using a data request, and a router that receives the data request, analyzes the data request using a burden calculator, and selects a selected storage provider based on results of a burden calculation.

The router might be configured to route a modified data request to the selected storage provider, the modified data request corresponding to the data request and the selected storage provider. The remote storage service might comprise cloud storage. The cloud storage might be configured to store data in data units and a data unit of the data units comprises one or more of an object, a data record, a file, a data block, a blob, and/or fixed length data field. The remote storage service might be storage accessible via one or more of a predetermined network interface, an application programming interface (API), and/or a network protocol. The burden calculator might determine a plurality of component burdens, at least one of which comprises egress fees, quota limits, data at rest charges, availability metrics, latency metrics, network location metrics, reliability metrics, and/or geographic region indicators. A component burden might comprise a customer preference measure representing a positive customer preference and/or a negative customer preference as to one or more particular storage provider. A component burden might be is adjusted to reflect a customer preference measure representing a positive customer preference and/or a negative customer preference as to one or more particular storage provider. The plurality of component burdens might include a jurisdictional component, wherein the jurisdictional component represents a burden and/or a constraint based on jurisdictional considerations of storing data in a particular jurisdiction. The jurisdictional component might represent a measure of data privacy, data security, and/or governmental data access laws or rules in the particular jurisdiction.

The burden calculator might include a rules-based module that applies rules to burden components and wherein the burden calculator might include a machine-learning module that determines burden components based on behavioral patterns and/or probabilistic predictions. The behavioral patterns might include one or more of regular access peaks, adaptive latency measures, throughput measures, and/or data transfer size price adjustments.

A method might comprise receiving a data request at a data request router from a requesting computer, wherein the data request relates to associated data associated with the data request and wherein the data request represents a request to store the associated data, retrieve the associated data, modify the associated data, forward the associated data, and/or delete the associated data, analyzing the data request using a burden calculator to determine a burden cost for each of a plurality of storage providers, and selecting a selected storage provider from among the plurality of storage providers based on respective burden costs of storage providers of the plurality of storage providers calculated by the burden calculator.

The method might comprise routing the data request to the selected storage provider. The method might comprise routing the data request to the selected storage provider comprises sending a modified data request corresponding to the data request and the selected storage provider. The data request might represent a request made to a remote storage service by the requesting computer, prior to selection of the selected storage provider. The remote storage providers might comprise cloud storage services configured to store data in data units and a data unit of the data units comprises one or more of an object, a data record, a file, a data block, a blob, and/or fixed length data field. The burden cost might comprise a plurality of component burdens, at least one of which might comprise egress fees, quota limits, data at rest charges, availability metrics, latency metrics, network location metrics, reliability metrics, and/or geographic region indicators.

The plurality of component burdens might include a jurisdictional component, wherein the jurisdictional component represents a burden and/or a constraint based on jurisdictional considerations of storing data in a particular jurisdiction. The jurisdictional component might represent a measure of data privacy, data security, and/or governmental data access laws or rules in the particular jurisdiction.

The method might further comprise determining burden components using a rules-based module to apply rules to burden components, and determining, using a machine-learning module, additional burden components based on behavioral patterns and/or probabilistic predictions.

A non-transitory computer-readable storage medium might store instructions, which when executed by at least one processor of a computer system, cause the computer system to carry out one or more of the methods described herein.

A computer system might comprise one or more processors and a storage medium storing instructions, which when executed by the one or more processors, causes the computer system to implement one or more of the methods described herein.

A computer system, as might be used for cloud infrastructure interactions, might comprise a requester computer that requests data from a remote storage service using a data request and an intermediate request router that analyzes the data request using a burden calculator and selects a selected storage provider based on results of a burden calculation. The remote storage service might comprise cloud storage, which might be object storage. The remote storage service might be storage accessible via an application programming interface, such as an Amazon S3 interface.

The burden calculation might include egress fees, quota limits, and/or geographic region indicators. The burden calculator might include a rules-based module that applies rules to burden components and wherein the burden calculator might include a machine-learning module that determines burden components based on behavioral patterns and/or probabilistic predictions. The behavioral patterns might include one or more of regular access peaks, adaptive latency measures, throughput measures, and/or data transfer size price adjustments.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is a diagram of a client-proxy-server platform illustrating relative positioning of a proxy in a multiple networked data storage service system architecture, according to various embodiments.

FIG. 2 illustrates an upload scenario with networked data storage services, according to various embodiments.

FIG. 3 illustrates a data download scenario between a client and multiple networked data storage services, according to various embodiments.

FIG. 4 illustrates a data locator system, according to various embodiments.

FIG. 5 illustrates a burden calculator, according to various embodiments.

FIG. 6 illustrates the data transaction monitor of FIG. 1 in more detail.

FIG. 7 illustrates an example computer system memory structure as might be used in performing methods described herein, according to various embodiments.

FIG. 8 is a block diagram illustrating an example computer system upon which the systems illustrated in FIGS. 1 and 7 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present invention has many applications, as will be apparent after reading this disclosure. In describing an embodiment of an intelligent proxy in a networked data storage service according to the present invention, only a few of the possible variations are described. Other applications and variations will be apparent to one of ordinary skill in the art, so the invention should not be construed as narrowly as the examples, but rather in accordance with the appended claims.

In a typical implementation of network storage, a user operates a client computer system that interacts as a client with a server computer system operated, owned, and/or maintained by a cloud service provider that interacts with the client as a server. Typically, many clients will be interacting with one or more servers, making requests and receiving responses from the servers. A network might exist to carry messages and data traffic between clients and servers. A client might be implemented by a computer, computer system, hardware, software, firmware, and/or some combination thereof. A server might be implemented by a computer, computer system, hardware, software, firmware, and/or some combination thereof.

Servers might implement one or more services. One such service is a networked data storage service wherein clients are remote from servers in that there is a network between them and wherein clients can make requests of one or more servers. Requests might include a request to store particular data at the server, modify data held or managed by the server, delete data held or managed by the server, return data held or managed by the server, etc. As such, the service is a networked data storage service. A networked data storage server might include some form of storage capability for data, which might vary from server to server and from time to time and might be opaque to clients. By pre-agreement, protocols and formats for client requests and server responses might be according to a specified protocol specific to a particular service. For example, the fields and formats of messages conveying a client request to store data might vary from service to service and the server's responses might vary from service to service. In a specific example, a client is expected to format a message that is a request to store data with a client identifier, followed by a size of the data object to be stored, parameters about the storage terms, and followed by the data object itself. The server might be expected, per the service's pre-agreed protocol, to respond with a confirmation message that includes an indication of success/failure of the request, a session identifier, a parameter indicating the cost to be billed for the storage (e.g., in units of currency per number of bytes per time period, such as dollars per gigabyte per day).

In a typical operation, a client might make a request to a server to store data specified in the request. The data might be included in the request or the request might include a link or reference to where a server can obtain the data to be stored. The server might respond with an acknowledgement of the storage request. The client might make a request for retrieval of data from the server and the server might respond with the requested data or a link or reference to where the client can obtain the requested data. Thus, data can flow in the client-to-server direction as well as the server-to-client direction.

A proxy can be a computer, computer device, software service, etc. that is operationally positioned between one or more client and one or more server. A proxy might be a proxy layer that is more involved than just a simple network node between a client and server. A proxy might be implemented by a computer, computer system, hardware, software, firmware, and/or some combination thereof. In a typical operation, a proxy layer is operationally between a client and a server such that the client interacts with the proxy as if the client were interacting with a server and the server interacts with the proxy as if the server were interacting with the client. Thus, the client would use the pre-agreed protocols to interact with the server but would actually be interacting with the proxy, while the server would use the pre-agreed protocols to interact with the client but would actually be interacting with the proxy. The proxy might be implemented as a distinct hardware device or might be software running on a virtual or shared host. The proxy might be transparent to the client and/or server and might emulate the protocols used between a client and a server, such as a server for a given networked data storage service and thus the client and the server would interact with the proxy as if the client and server were interacting directly, emulating the protocol conversations as needed. In other instances, the replies from the proxy might illuminate that a rerouting has occurred. If so, it can be done in such a way that the data requester handles it similar to how it would handle a response where the proxy was not used.

A particular protocol for interaction might be used by a client for a data transfer that is an upload of data from the client to the server for the intended purpose of having that data stored in one or more networked data storage services. Another particular protocol for interaction might be used by a client for a data transfer that is a download of data from the server to the client, retrieving data stored in one or more networked data storage services.

Interacting with a remote service managed by others can incur burdens, such as financial burdens like costs to use the service, security burdens, bandwidth burdens, latency burdens, reliability measurements, etc. A burden calculator might be implemented by a client and/or a computing platform operated by an operator of a client. For example, a company or other entity or person who desires to have a remote networked data storage service store a large corpus of data might have a client that uploads the large corpus of data to the remote networked data storage service using the pre-agreed protocols of that service and has a burden calculator that computes a cost of that storage activity, a cost to later retrieve that stored data, a measure of the difficulty of handling that data, another measure of security risks taken, a performance measure, a reliability measure, a regulatory burden, etc. The burden calculator might maintain a database of the burdens associated with many individual storage activities. A burden might have an associated value that might be determined according to preselected, automatic, and/or default sets of preferences. Relative comparisons of different burdens might be used to select a preferred service from a plurality of available services. For example, a client operator might determine that certain data needed to be stored by some networked data storage service and based on the amount to be paid to store the data, they (or the client) would opt for a lower-cost storage provider. In another instance, the operator (or the client operating on programmed rules) might opt for a particular storage provider due to a regulatory burden that prevents the client from storing that data on servers in certain countries due to the nature of the data and regional data restrictions.

A burden calculator may have predetermined models for networked data storage services that include factors such as egress fees, storage fees, capacity limits, bandwidth shaping, etc. These factors might be static or dynamic and change over time. For example, data transfer factors may vary over time between providers and might be modeled continuously to detect for service outages or bandwidth congestion. Other factors, such as egress fees, may remain static for long periods of time. As networked data storage service services evolve, the models used can also evolve to accommodate the changes. These models can be built from considering published rules and rate sheets of various networked data storage providers and/or from recordings of prior experiences and charges. These might be constructed on a provider-by-provider basis or grouped so that a model covers multiple providers and/or a model covers less than all of a provider's offerings and a provider might be covered by multiple models.

In general, a burden cost can be computed on a unit-by-unit basis with the unit being the quantum of requests, such as object-by-object burden calculations. Thus, the burden calculator can generate a value for a data request, whether the request is for storage, processing, retrieval, modification, etc., that can be used to decide how to route that data request. Where the data request relates to a data record, the burden cost value generated can be for that data record, where the data request relates to a data object, the burden cost value generated can be for that data object, etc. Where a data request can be parsed into more than one split data request or more than one data requests can be combined into one combined data request, the burden cost might be calculated for each of the split data requests or combined data requests.

A conventional client might be configured for a specific networked data storage service. The client might be implemented using protocol libraries to facilitate basic integration between the client and a specific networked data storage service. Such a client might not be compatible generally across different services, as different services might have different protocols and react differently for error response and handling behavior.

Larger services typically have their own proprietary protocols. While the specifications for these might be publicly available, they are not usually controlled by an independent industry body and can be subject to unmanaged change. While changes are expected as services evolve, this can cause integration challenges and interoperability issues. Additional complexities can arise with these protocols if they incorporate digital signatures and other cryptographic methods, unique to the networked data storage service, to ensure the integrity of the data.

Migrating from a single networked data storage service to a second networked data storage service can create complexity in the client implementation. There can be added complications with determining which networked data storage service has the content that the client is requesting, failover logic for outages, and in complex implementations, the burden calculator functionality.

As explained with reference to examples herein, a cloud services consumption manager system, comprising one or more computers capable of communications and data transfers, might interact with various cloud computing systems. In general, a cloud computing system might perform computations, data storage and retrieval, and other computing tasks possibly subject to burdens on users, such as costs imposed and technical limitations. A cloud services consumption manager system might include a proxy layer (comprising one or more proxy systems) that is agnostic as to particular cloud computing system. Using the proxy layer, the cloud services consumption manager system can optimize on the imposed burdens for interactions between a user's client system and the cloud computing systems in use. For example, where a cost of an operation by one cloud computing system is much greater than if performed by another cloud computing system, the proxy layer could transparently or non-transparently cause the operation to be performed by the latter cloud computing system.

In general, a cloud services consumption manager system might optimize a set of operations based on burdens involved with those operations, such as reducing or minimizing financial costs, reducing or minimizing throttling, reducing or minimizing bandwidth limits, etc. Burdens, or burden factors, might be represented in computer memory as variables reflecting values for egress charges, bandwidth limits, egress capacity limits, availability, access restriction, geographic restrictions, and the like. Burden optimizations might be cost optimizations calculated at each client request resulting in the most cost-efficient data access.

The proxy layer might automatically calculate an efficient networked data storage service for the data given various burden factors or cost factors. In a protocol where the data response is chunked into multiple segments and reconstructed by the client, the proxy layer allows for dynamic switching between networked data storage services for a single request as burden factors change.

Where performance optimization is heavily biased, the proxy layer can concurrently request the data from multiple networked data storage services, such that various segments of the complete data set are obtained from different networked data storage services.

The proxy layer might monitor availability of a networked data storage service such that when detecting an outage at a specific networked data storage service, regardless of reason, the proxy layer can automatically route requests to an alternate available networked data storage service of the data. The networked data storage service changeover can be transparent to the client, minimizing the need for failover management by the client.

Detailed examples of methods and apparatus for implementing a cloud services consumption manager system and related methods and apparatus will now be described.

In a specific implementation, various clients and servers use an S3 protocol for client requests and server responses. A requester computer might execute S3 requests based on user credentials supplied by a user (human, computer, etc.) that has the user credentials to execute such requests. An example request might be a GET request to retrieve data directed to an endpoint. A proxy, or a router between requesters and servers, handles the request, reformatting it as needed for submission to a server of a particular provider. The provider might operate a remote storage device comprising an S3 endpoint, such as an Amazon Web Services (AWS)(tm) facility or a Google Cloud(™) server.

A burden calculator can compute relative burdens (cost burdens, etc.) among providers and select a best match between requester, the request and a provider. The relative burdens might take into account availability of an endpoint, egress cost, egress cost beyond a bandwidth threshold, latency, reliability, throughput, data caps. In some implementations, an output of a burden calculator is a burden value that is a scalar value for a given set of calculator inputs. The scalar value might be a weighted sum of a set of burden components and might be represented in arbitrary units or monetary units. The scalar value might have nonlinear aspects of combinations of burden components. Where applicable, the burden cost might be represented as a scalar value or as a vector value that can be later combined with additional information into a cost value or otherwise used for selection among remote service providers.

For example, burden components might be determined in units of dollars per gigabyte per month using suitable predetermined or computed conversion values. As one specific example, a burden calculator might compute a burden value of X dollars per gigabyte per month by summing a set of components wherein a first component is a per gigabyte egress cost in dollars times a predetermined estimate of an egress volume expected per unit time, a second component is a per gigabyte storage cost in dollars times a number of gigabytes of the request, and a third component is a jurisdictional cost associating with storing the data of the request on a server that is subject to the rules, regulations, and laws of a particular jurisdiction.

In some embodiments, the burden calculator can handle multidimensional cost variables, optimizing to minimize or reduce monetary cost, to minimize or reduce latency, and/or to maximize or increase throughput. By computing burden values for the data of a given data request for a plurality of possible storage options, a proxy can select among that plurality of possible storage options for the option that has the lowest burden value. Additional considerations might be taken into account beyond just the burden value or, in some cases, any considerations that would affect selection of where to route a data request's data might be included in some burden component.

In some embodiments, data source selection logic may use a Bloom filter, which can provide rapid determination of the presence of a requested data transfer on each networked data storage service. A Bloom filter might be used and populated by the proxy during upload or replication of data. The Bloom filter might be populated independently of any data requests such that it could hold complete availability of all data that could be serviced by each data storage provider.

Some embodiments might use a stateless implementation wherein each available networked data storage service is queried by the proxy to determine whether it can service a data object download request. One or more queries can apply to one or more networked data storage service.

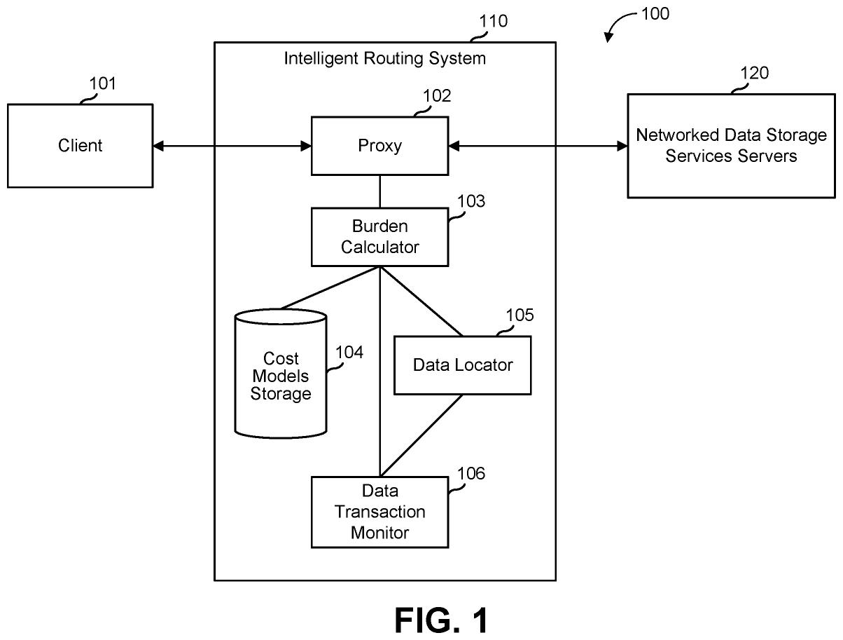

FIG. 1, illustrates a system architecture 100 and relative positioning of a proxy 102 for use with multiple networked data storage services. A client 101 communicates with proxy 102 instead of each networked data storage service 120 independently. Proxy 102 can use a data locator 105 to determine which of networked data storage services 120 can deliver the requested data. A burden calculator 103 utilizes cost models 104 for the relevant networked data storage services 120 to determine a most cost-effective networked data storage service 120 from which to source the content.

Under certain circumstances, the data may be sourced from multiple networked data storage services 120 simultaneously and reconstructed by an intelligent routing system 110 before being returned to client 101. One example is where data transfer is originally initiated with a first networked data storage service, and during the transfer of data, an error or limitation occurs, such as a network failure or bandwidth limitation, etc. Intelligent routing system 110 can finish the remainder of the data transfer with a second networked data storage service without the need to initiate the data transfer from the beginning. A second example is where the client preferences favor data transfer performance. Intelligent routing system 110 can initiate data transfer from multiple points of presence within a single networked data storage service, or multiple networked data storage services 120, to maximize data transfer efficiency to retrieve and reconstruct the data requested by client 101.

Intelligent routing system 110 can be implemented by various logical components and could be implemented in a single component or independent, distributed components to achieve the functionality described herein.

Capabilities of intelligent routing system 110 might differ based on the direction of data transfer. In the event that client 101 is transferring data to one or more networked data storage services 120, intelligent routing system 110 might consider this an upload.

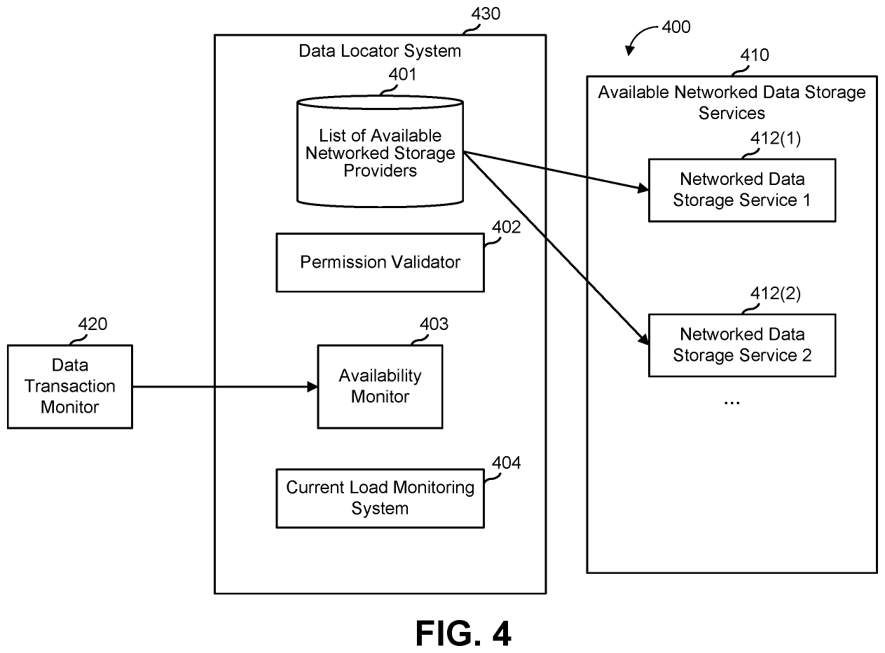

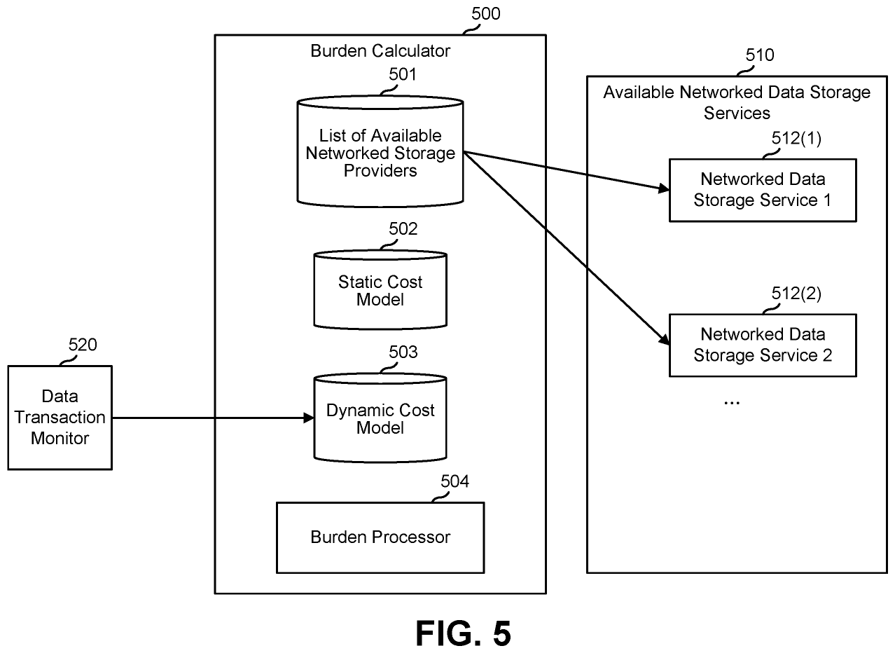

Intelligent routing system 110 proxies active downloads between the selected networked data storage services 120. The performance, availability, and response status of data downloads are monitored by a data transaction monitor 106. A role of data transaction monitor 106 includes providing feedback to data locator 105 and burden calculator 103 for consideration in an availability monitor 403 (see FIG. 4) and a dynamic cost modeler, such as dynamic cost modeling information storage 503 (see FIG. 5). Data transaction monitor 106 can aggregate time-sensitive metrics for networked data storage services 120 that allow intelligent routing system 110 to incorporate real-time availability and performance characteristics of networked data storage services 120 into decisions of which networked data storage service will be chosen to service a given data transfer request.

In some embodiments, the burden calculator might provide for inputs related to customer preferences to provide different results for data source selection. For example, a data manager might prefer a particular data storage service for intangible, immeasurable, or other reasons that might not already be accounted for in the burden calculator's computations. A data manager might prefer a particular data storage service because some relationship between the data manager's organization and a particular data storage service, such as where the organization has an interest in particular data storage service, a desire to consolidate business, or some strategic reason. It may be that the organization prefers a particular data storage service because of how the data storage service treats its customers or prefers to avoid another particular data storage service because of how that data storage service operates. In such cases, those additional inputs can be provided as customer preferences that might be used as weights for burden calculations.

The additional, customer preference, inputs might be processed as a separate burden component or the customer preference inputs might be reflected in changes to burdens of other components. For example, a customer preference might be taken into account by the burden calculator changing a data storage cost burden value (e.g., by some percentage such as a 2% to 5% reduction in assumed costs) so that if all other factors are equal except that a favored data storage service provider charges 1% more, that favored data storage service might be selected despite charging slightly more.

The customer preference can be represented as one component burden of the plurality of component burdens. The customer preference might be a positive customer preference as to one or more particular storage provider or a negative customer preference as to one or more particular storage provider. The customer preference might be implemented not as its own component but an adjustment of another component, adjusted to reflect a customer preference measure representing a positive customer preference and/or a negative customer preference as to one or more particular storage provider.

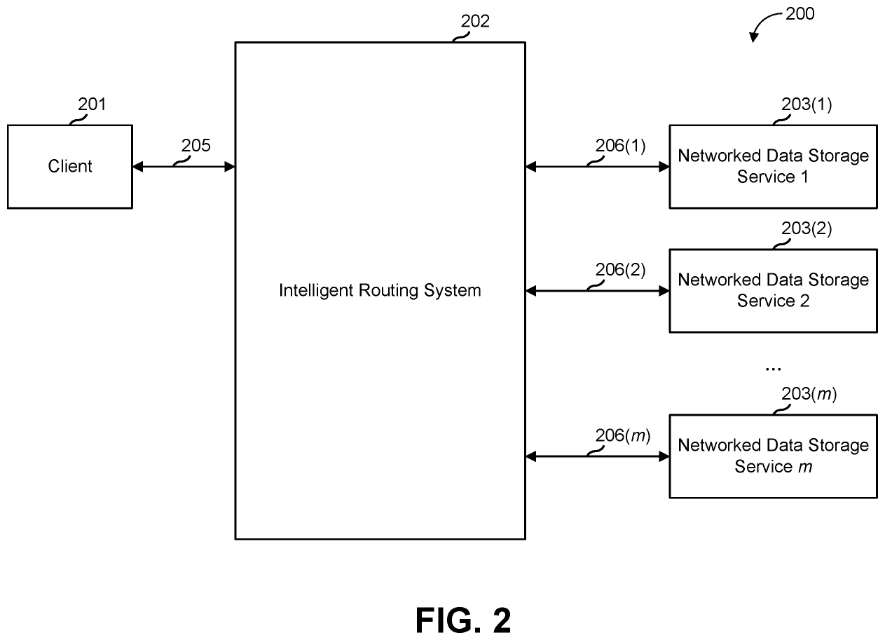

FIG. 2 illustrates an upload scenario with two networked data storage services 203(1) and 203(2) shown. In other examples, there might be more than two networked data storage services; a typical implementation might have a larger number, m, of networked data storage services to be supported. In this upload scenario, a client 201 is uploading data to an intelligent routing system 202, which in turn, uploads the data to one or both networked data storage services 203. Client 201 can be configured to be unaware of the number of copies that are uploaded to various networked data storage services 203. To client 201, the upload can appear to be a single upload to intelligent routing system 202. Decision logic for where the data resides can be removed from client 201 and intelligent routing system 202 can handle the logic and configuration relative to which networked data storage services 203 receive the data upload.

In a first embodiment, data may be uploaded only to a first networked data storage service 203(1). In a second embodiment, data may be uploaded to only a second networked data storage service 203(2). In a third embodiment, data may be uploaded to all networked data storage services 203. In each embodiment, client 201 might be unaware of the final destination of the data upload.

FIG. 2 also illustrates that a first protocol might be used in a channel 205 between client 201 and intelligent routing system 202 and a second protocol in a channel 206 between intelligent routing system 202 and a networked data storage service 203. The protocols in channels 206(1) and 206(2) might be different or the same. The first protocol and the second protocol might be the same protocol or completely different protocols, and each protocol between each component shown in FIG. 2 can be implemented by both of the relevant components. Intelligent routing system 202 can thus facilitate data upload across multiple protocols.

A complexity in supporting upload across multiple protocols is that inherent capabilities of each protocol may vary significantly. In one embodiment, all protocols are the same protocol. While there may be implementation differences, the common capabilities of each implementation have substantial, if not complete, overlap. Subtle differences in implementation or configuration can lead to data upload errors. Consider the case of a data upload that is segmented into multiple upload parts. This is a common scenario in computer networking, commonly referred to as “chunking” or multi-part uploads. While all implementations of the protocols on channels 205, 206(1), and 206(2) might support this capability, the configuration of data upload limit for a given “chunk” might be different for each networked data storage service 203. In this instance, intelligent routing system 202 can independently manage data upload size for each networked data storage service 203 such that the data upload is not subject to degradation to the lowest performing service of networked data storage services 203.

In a second embodiment, networked data storage service 203(1) may implement a first protocol over channel 206(1), while networked data storage service 203(2) may implement a second protocol over channel 206(2). In this embodiment, the first protocol over channel 206(1) and the second protocol over channel 206(2) might be entirely different protocols, wherein they might have a common capability to support some form of data upload. In this embodiment, intelligent routing system 202 implements the client side of both the first protocol and the second protocol. Neither the first protocol nor the second protocol need have any relationship to the protocol used on channel 205 between client 201 and intelligent routing system 202. Intelligent routing system 202 can implement the server side of the protocol on channel 205 and manipulate the data payloads to the specific needs and implementations of the protocol used on channel 206(1) and the protocol used on channel 206(2). In this manner, client 201 is isolated from the complexities of managing multiple networked data storage services.

In a third embodiment, networked data storage service 203(1) might implement a first cryptographic system to ensure the integrity of the data transmission, while networked data storage service 203(2) might implement a second cryptographic system. In this embodiment, the intelligent routing system 202 implements the second cryptographic system when communicating the data transfer to the second networked data storage service 203(2). In this manner, the client 201 is isolated from the complexities of managing cryptographic systems implemented by each networked data storage service 203.

In a fourth embodiment, networked data storage service 203(1) might implement a first authentication mechanism for accessing the service, while networked data storage service 203(2) might implement a second authentication mechanism for accessing the service. The authentication mechanisms might be similar; however, they might be completely independent. In this case, the intelligent routing system 202 manages the authentication mechanism for each networked data storage service to ensure that the appropriate authentication credentials are presented to each networked data storage service 203 to validate the client for the data transfer.

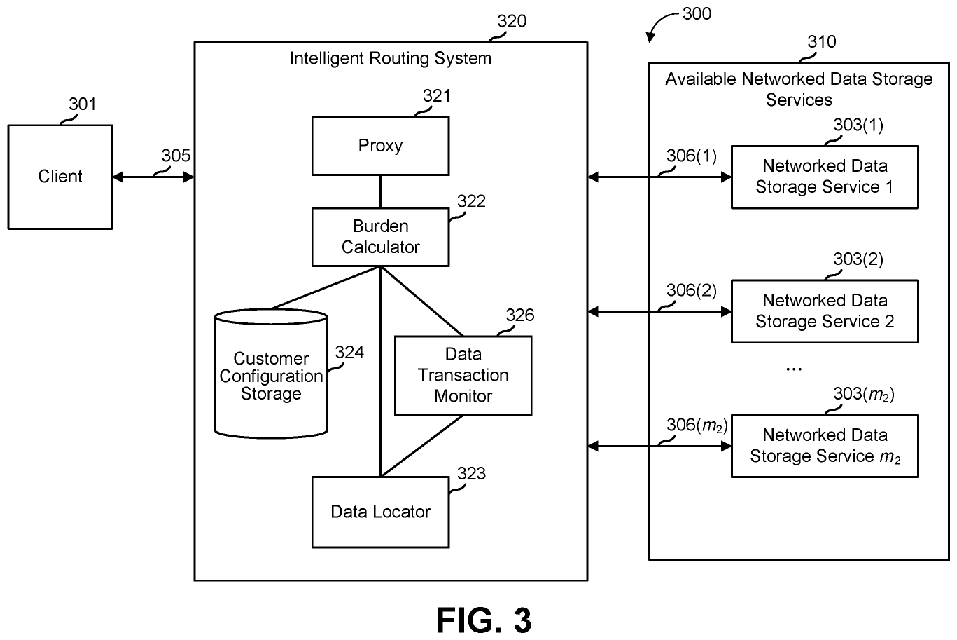

FIG. 3 illustrates the data download scenario between a client 301 and multiple networked data storage services 310. In this instance, an intelligent routing system 320 locates content from available networked data storage services 310 using a data locator system 323, retrieves the preferred configuration from a customer configuration storage system 324, and utilizing the burden calculator 322 determines which networked data storage services 310 should be utilized for the data download. A data transaction monitor 326 can monitor data transactions. The data download might be initiated from one or more of a set of available networked data storage services based on a preferred configuration.

Similar to the data upload scenario illustrated in FIG. 2, there is no requirement that the protocols on channels 305 and 306(1)-(m₁) share any commonality other than a capability of data download. Additionally, client 301 need not have awareness of the protocol differences between one or more selected networked data storage service 303 from where the data download will be sourced.

Intelligent routing system 302 may itself provide capabilities of a networked data storage service 303. The protocol used on channels 306(1), (2), . . . , 306(m₁) may be application programming interfaces or “APIs” rather than networked protocols. This applies to both the upload description from FIG. 2 and the download description in FIG. 3.

FIG. 4 illustrates a platform 400 including a data locator system 430. Data locator system 430 can be used for both data uploads and data downloads, although the utilization of each specific capability may vary between these two scenarios. Basic components of data locator system 430 might include an available networked data storage service capability list 401 that contains indications of which of the set 410 of networked data storage services 412 that can be used for the given data operation. These components might include a permission validator 402 that ensures the appropriate access controls are afforded to the system for the given data operation, availability monitor 403 for determining a current availability of each available networked data storage service, and a current load monitoring system 404 for each available networked data storage service. Whilst each of these functional components may be implemented in different subsystems of intelligent routing system such as intelligent routing system 110 shown in FIG. 1, they are functionally grouped here for convenience of description. Not all of these are required.

An available networked data storage service capability list 401 lists the networked data storage services that have been configured for the given data operation. While a given embodiment may have a single set of available networked data storage services 412, the granularity at which set 410 is applied can vary. Each data operation can be considered as having an independent set of available networked data storage services.

When the set of available networked data storage services is established, permission validator 402 determines a set of available networked data storage services for which an intelligent routing system has appropriate permissions to perform the requested data operation. For example, consider the case where intelligent routing system 202 of FIG. 2 has permissions to upload and download data from a first networked data storage service 412(1) but only has permission to download data from a second networked data storage service 412(2). In the case of a data upload operation, permission validator 402 would exclude networked data storage service 412(2) due to insufficient permissions. Permission validator 402 can be a separate component or its functionality can be combined with other functional components in a real-world implementation. Similarly, the capability described by permission validator 402 is optional and can be similarly achieved for each data operation in flight, by responding to appropriate protocol error responses.

An additional consideration when selecting the final set of available networked data storage services may be the current availability of each networked data storage service. Availability monitor 403 might handle tracking the current state of availability of each specific service instance for each available networked data storage service. This allows data locator system 430 to exclude a given networked data storage service from the final set based on current service availability. While this may be an independent service, it is described in the context of data locator system 430 for the purpose of conceptual simplicity rather than a specific embodiment. The capability described herein can be performed using a sequential logic flow, or not, and can be a capability in a final embodiment of an intelligent routing system. For example, availability monitor 403 could include data storage service capability list 401.

One embodiment of availability monitor 403 could utilize data collected by a data transaction monitor 420 that can maintain metrics on the current or recent transactions with each networked data storage service 412. For example, data transaction monitor 420 might provide success, failure, or timeout information for networked data storage service 412(1) that indicates that the last N data transactions with networked data storage service 412(1) have failed or timed out, where the value of N could be three, less than three, greater than three, and/or set by some stored parameter. Availability monitor 403 could determine that networked data storage service 412(1) is demonstrating poor availability and choose to remove networked data storage service 412(1) from set 410 of available networked data storage services. The logic applied by the availability monitor 403 could include a sliding time window aspect, such that the consideration of information provided by data transaction monitor 420 is limited to transactions within a specified time window, thus ensuring that the availability status of a given networked data storage service 412 is not indefinitely stuck in a failed state. A sliding time window is an optional implementation detail that might not be implemented for a capability of availability monitor 403.

A current load monitoring system 404 provides a final, optional capability that may bias the result of data locator system 430. Current load monitoring system 404 is responsible for managing data operation load across each instance of an available networked data storage service. This allows an intelligent routing system to minimize quality of service degradation from a given networked data storage service due to data operation volume.

One embodiment of current load monitoring system 404 could be a finite queue, where the number of in-flight data operations are limited by the depth of the queue. For example, the queue depth for networked data storage service 412(1) may be ten operations, while the queue depth for networked data storage service 412(2) may be one hundred operations. While each queue remains below ten data operations, current load monitoring system 404 may respond with both networked data storage service 412(1) and 412(2) as being available. Once the queue of networked data storage service 412(1) reaches ten concurrent data operations, current load monitoring system 404 would remove networked data storage service 412(1) from subsequent responses until the queue for networked data storage service 412(1) had available space. In this manner, current load monitoring system 404 dynamically manages the response to a given data operation to ensure networked data storage service availability.

A second embodiment of current load monitoring system 404 could include a provider bias factor that accounts for time-of-day load fluctuations. As a simplistic example, consider two available networked data storage services 412, a first networked data storage service located in San Francisco, California, and a second networked data storage service located in London, England. As networked data storage services often observe increased service load during normal local business hours, a data transfer request from a customer's client system might have different burdens based on where it originated. A data transfer request originating in New York, NY at 8:00 AM Eastern Standard Time may result in the second networked data storage service load being significant, since this data transfer request occurs in the early afternoon in London. The first networked data storage service in San Francisco, California load may be low, since this data transfer request occurs at 5:00 AM Pacific Standard Time. As such, the current load capability could favor data transfer requests to the first networked data storage service based on time-of-day and relative time zone locations of the set 410 of available networked data storage services for servicing the data transfer request. In addition to time-of-day load characteristics, there would be day-of-week load characteristics, and seasonal load characteristics, such as local holiday load patterns. For example, consider the same scenario described in the second embodiment, where a data transfer request originates from New York, NY on the Friday after Thanksgiving. In the USA, this is typically a day of high load volume on the first networked data storage service based in San Francisco, California. The current load monitoring system could include this into the bias factor and direct the request to be fulfilled via the second networked data storage service, even though this may be a higher load time-of-day for the second networked data storage service.

The bias factor could be handled at a conceptual level rather than a specific implementation. The bias factor could be statically modeled based on heuristics and/or dynamically adjusted in real-time based on networked data storage service performance characteristics. Current load monitoring system 404 can include logic that selects a primary networked data storage service from the set 410 of available networked data storage services based on a notion of implied or actual load on each individual networked data storage service.

Similarly, while current load monitoring system 404 is depicted as a logical capability in FIG. 4, it may be implemented as part of a burden calculator rather than a separate component of data locator system 323 in FIG. 3. Current load monitoring system 404 might be responsible for continuous monitoring of the transaction load with each networked data storage service.

FIG. 5 illustrates a burden calculator 500, which can be applicable to both data upload and data download scenarios, although the utilization of each specific capability may vary between these two scenarios. Burden calculator 500 can maintain a listing 501 of a set 510 of available networked data storage services 512 that have been identified by the data locator system described in FIG. 4 as being able to service the current data transfer request. Each of available networked data storage services 512 might have cost modeling characteristics represented in static cost modeling information storage 502 and dynamic cost modeling information storage 503.

One embodiment of a static cost model could include pricing for the storage of data at rest, along with pricing for transferring the data into or out of the networked data storage service. Burden calculator 500 can consider a set of relevant static characteristics based on the data transfer request to select a given networked data storage service to service the specific data transfer request. A burden processor 504 might handle the calculations.

One embodiment of a dynamic cost model could include the data transfer error rate for a given networked data storage service during a specific past period, such as for the past five minutes, the past half hour, etc. Since the data transfer error rate might adjust with each data transfer request, this factor can be calculated dynamically with each data transfer request. The data transfer error rate could be modeled by the error rate over some set of past transfer requests, such as the past three requests, the past ten requests, the past 30 requests, etc. A combination of dynamic factors could be considered by dynamic cost model to aid in the selection of the preferred networked data storage service by burden calculator 500.

A static cost model stored in static cost modeling information storage 502 for a given networked data storage service 512 can include factors that never change or change only infrequently. As such, the static cost model does not require frequent update and therefore is applicable to caching. A margin of error based on the update frequency of the static cost model for a given networked data storage service may be deemed acceptable for the computational efficiency obtained.

The static cost model may include heuristic factors that are based on observed service patterns by a given networked data storage service. Suppose networked data storage service 512(1) has an average egress bandwidth of 1 Gbps (gigabits per second), as might have been determined from data transfer transactions over time and included in a dynamic cost model and stabilized sufficiently to be included in the static cost model. While this may not be indicative of the egress bandwidth for one specific data transfer request, it provides a heuristic estimate of the expected egress bandwidth that can be factored into the cost calculator selection.

Factors that may be relevant to a static cost model may include, but not be limited to, monetary pricing for data transfer and data storage at rest, regional pricing differences, regional data transfer restrictions (such as GDPR), internal data migration costs, data transfer limits, and pricing tiers. Burden calculator 500 may consider none, some, or all of these static cost model factors in determining a preferred one of the set 510 of available networked data storage services, based on the data transfer request and the customer configuration.

A dynamic cost model as might be stored in dynamic cost modeling information storage 503 for a given networked data storage service can include factors that change frequently between data transfer requests, over time, or both. The dynamic cost model can contain relevant factors that change frequently and are sufficiently important to the cost calculation to be retrieved for each data transfer request. Additionally, the dynamic cost model can include data transfer request characteristics from previous data transfer requests. One example of this is a data transfer limit.

For illustrative purposes, consider a first networked data storage service 512 that has data transfer pricing tiers. A first tier may be free for data transfer up to 1 TB (terabyte) per day. A second tier may charge $1 for data transfer above 1 TB per day. This may become significant in the cost calculation for a given customer; therefore, the dynamic cost model would include indications of the amount of data transferred between the first networked data storage service 512 and a customer.

Factors that may be relevant to a dynamic cost model may include, but not be limited to, data transfer limits and pricing tiers, concurrent data transfers, network traffic shaping on data transfers, networked data storage service availability, or other temporal networked data storage service characteristics. Burden calculator 500 may consider none, some, or all of these dynamic cost model factors in determining a preferred one of the set 510 of available networked data storage services, based on the data transfer request and the customer configuration.

Burden calculator 500 may apply hysteresis to dynamic cost model factors to avoid issues with oversampling. Applying hysteresis to dynamic cost model factors provides an optimization of networked data storage service selection. Consider the scenario where the acceptable data transfer request error rate is set to 5%, meaning that one data transfer request out of twenty data transfer requests has an error. When a first networked data storage service's data transfer request error rate falls below the acceptable threshold of 5%, burden calculator 500 may limit the number of requests sent to this first networked data storage service until the data transfer request error rate falls below 2%. In one embodiment, the data transfer request error rate is calculated using a sliding window of the past 100 data transfer requests. The first networked data storage service would have to achieve 98 successful data transfer requests out of the past 100 data transfer requests to remove the limitation imposed by burden calculator 500.

The calculation of dynamic cost model factors could be performed by an independent process. For example, in the scenario described in the previous paragraph, the sampling of error rate for the first networked data storage service could be achieved through dummy transactions generated by burden calculator 500 rather than utilizing customer transactions. Additionally, this may affect the availability status of the first networked data storage service that can be used to circumvent complex processing by the cost calculator.

Burden calculator 500 can determine a prioritized set of available networked data storage services that can service a given data transfer request. Burden calculator 500 can utilize algorithmic efficiencies to optimize performance. This could include, but not limited to, avoiding costly calculations based on Boolean factors. One example of this would be an availability flag for a first networked data storage service. This availability flag would indicate if the first networked data storage service is servicing data transfer requests. If the availability flag is set, this would indicate that the first networked data storage service is accepting data transfer requests. Burden calculator 500 could then continue evaluating additional cost model factors to determine the rank of this first networked data storage service compared to other available networked data storage services. If the availability flag is not set, this would indicate that the first networked data storage service is not accepting data transfer requests. Burden calculator 500 would avoid considering any further cost model factors, since the first networked data storage service is unable to service the data transfer request.

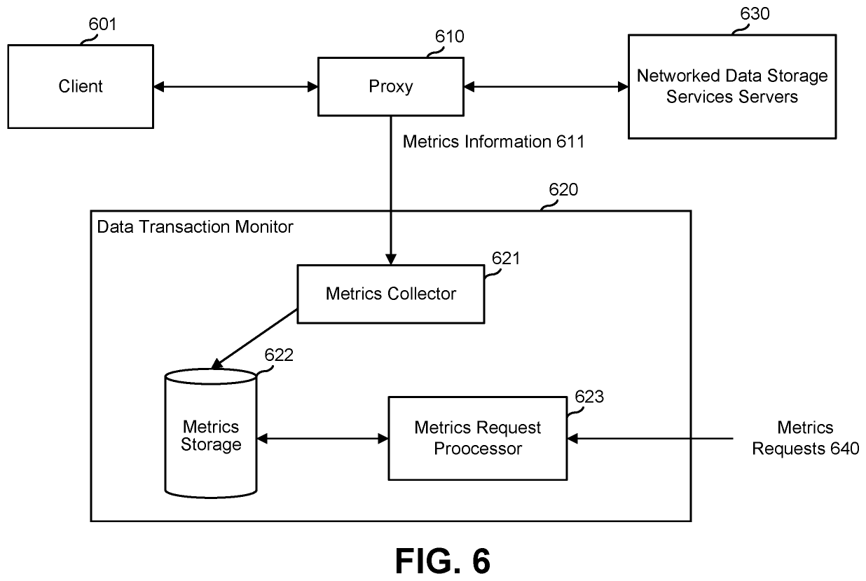

FIG. 6 illustrates an example of a data transaction monitor 620 in more detail. Data transaction monitor 620 collects metrics on each transaction flowing through a proxy 610, between a client 601 and networked data storage services 630. Metrics information 611 provided to data transaction monitor 620 is associated with the specific networked data storage service involved in the transaction. The metrics apply to both uploads and downloads and are received by a metrics collector 621 responsible for ensuring accurate receipt of metrics information, prior to storing the relevant metrics associated with each networked data storage service in a metrics storage 622. A metrics request processor 623 is responsible for servicing requests for metrics data from other components of intelligent routing system 110, such as availability monitor 403, and dynamic cost modeling information storage 503.

Metrics information 611 can be pushed from proxy 610 to metrics collector 621 at the completion of each data transaction and/or it can be aggregated by proxy 610 and provided upon request by metrics collector 621.

Metrics information 611 is associated with each specific data transaction and can comprise characteristics for the specific data transaction that are relevant to determining the performance and availability of the networked data storage service 630 involved in the data transaction. One embodiment of metrics information 611 is the success or failure of the data transaction, the IP address of client 601, that originated the data transaction, the IP address of the networked data storage service 630 that is servicing the data transaction, and the data transfer speed for the data transaction. In the event of failure of the data transaction, the specifics of the error, such as an error code, can be included in metrics information 611. Typically, an error code will be specific to the protocol implemented by networked data storage service 630, in which case, metrics collector 621 may provide normalization of error codes such that protocol variants of error codes are consolidated into an internal set of standard errors within a data transaction monitor 620.

Data contained within metrics information 611 can vary with each implementation and can be extensible to include additional data as it becomes relevant to the implementation. The required data fields might be determined by the specific implementation. In one embodiment, there may be no required data fields in metrics information 611, while in a second embodiment, one or more data fields will be required. The responsibility to ensure that any required data fields are present in metrics information 611 might fall to metrics collector 621.

Metrics collector 621 might be responsible for receiving metrics information 611, ensuring its veracity, normalizing the information, and saving it in metrics storage 622. Ensuring veracity of the metrics information may include, but is not limited to, ensuring all required data fields are present and accurate. For example, the source IP of the requesting client 601 may be a required data field in metrics information 611. In this example, ensuring the veracity of this data field could include ensuring that data is present in the field, that the IP address conforms to Internet standards for IPv4 or IPv6 addresses, that the IP address is within a publicly accessible range, that the IP address is not on a blocklist, etc.

Metrics collector 621 may implement normalization of success and error conditions, and error codes that exist between implementation of the same network protocol between different network data storage services, or different network protocols for facilitating the data transfer. Normalization of data may extend to other data fields contained in metrics information 611. Normalization can be used to maintain an internally consistent view of metrics information 611 regardless of the specific implementation of the data being collected by proxy 610, to support extensibility of data transaction monitor 620 to operate with various implementations of proxy 610.

Metrics storage 622 is responsible for maintaining the metrics data for servicing metrics requests 640. Metrics storage 622 can be persistent storage that can take various forms such as a database, a flat file, a document store, a persistent queue, etc. The specific form of metrics storage 622 might be implementation specific. Metrics storage 622 may include implementation of a sliding time window applied to the data, so that the metrics information is aged out over time. While this is an optional capability of metrics storage 622, it could also be implemented in other components of metrics request processor 623. For example, the metrics information might not be aged out and yet metrics request processor 623 may limit the metrics information returned in response to a metrics request 640 to a sliding time window.

Metrics request processor 623 might be responsible for servicing requests by various components of intelligent routing system 110 to provide relevant metrics information to the requesting component. The specific metrics information returned may vary based on the metrics request and is not necessarily limited to a single networked data storage service 630. In one embodiment, metrics request 640 may be a request for specific data fields for a single networked data storage service 630. In a second embodiment, metrics request 640 may be a request for all data fields for a single networked data storage service 630. In a third embodiment, metrics request 640 may be a request for all data for multiple networked data storage services 630. The specifics of the metrics request 640 granularity might be implementation specific.

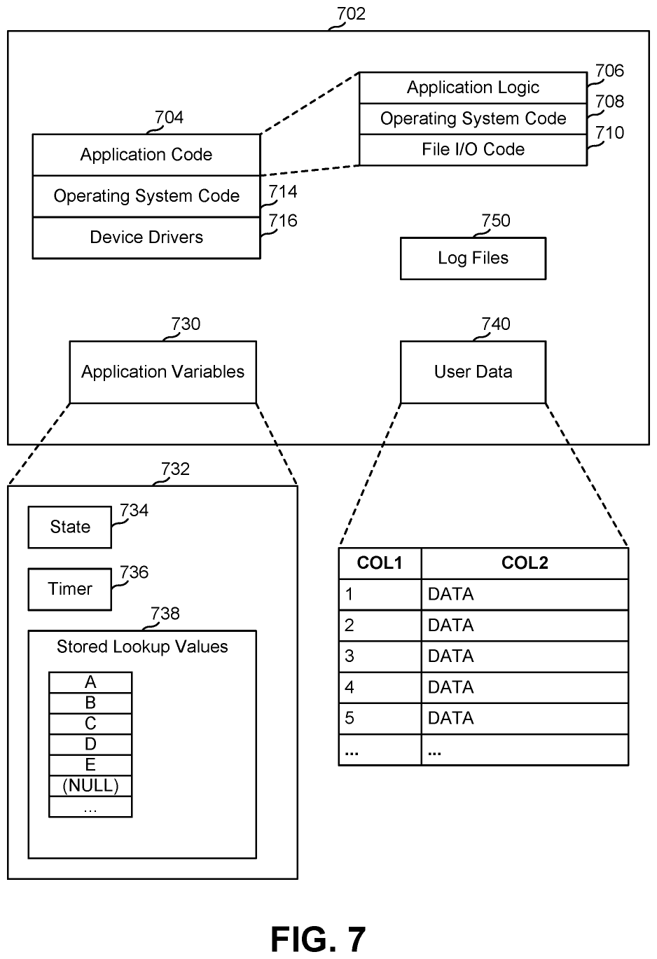

FIG. 7 is a simplified functional block diagram of a storage device 702 storing an application that can be accessed and executed by a processor in a computer system as might be part of embodiments of a data management system and/or a computer system that handles cloud infrastructure interactions. FIG. 7 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 702 can be one or more memory device that can be accessed by a processor and storage device 702 can have stored thereon application code 704 that can be one or more processor readable instructions, in the form of write-only memory and/or writable memory. Application code 704 can include application logic 706, library functions 708, and file I/O functions 710 associated with the application. The memory elements of FIG. 7 might be used for a server or computer that interfaces with a user, generates data, and/or manages other aspects of a process described herein. In addition to application code 704, storage device 702 might also contain operating system code 714 and device drivers 716.

Storage device 702 can also include storage for application variables 730 that can include one or more storage locations configured to receive variables 732. Application variables 730 can include variables that are generated by the application or otherwise local to the application, such as state variables 734, timers 736, and/or stored lookup values 738. Application variables 730 can be generated, for example, from data retrieved from an external source, such as a user or an external device or application. A processor can execute application code 704 to generate application variables 730 provided to storage device 702. Application variables 730 might include operational details needed to perform the functions described herein.

Storage device 702 can include storage for databases and other data described herein. One or more memory locations can be configured to store user data 740, which might include data sourced by an external source, such as a user or an external device. User data 740 can include, for example, records being passed between servers prior to being transmitted or after being received. Other data might also be supplied.

Storage device 702 can also include log files 750 having one or more storage locations configured to store results of the application or inputs provided to the application. For example, log files 750 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

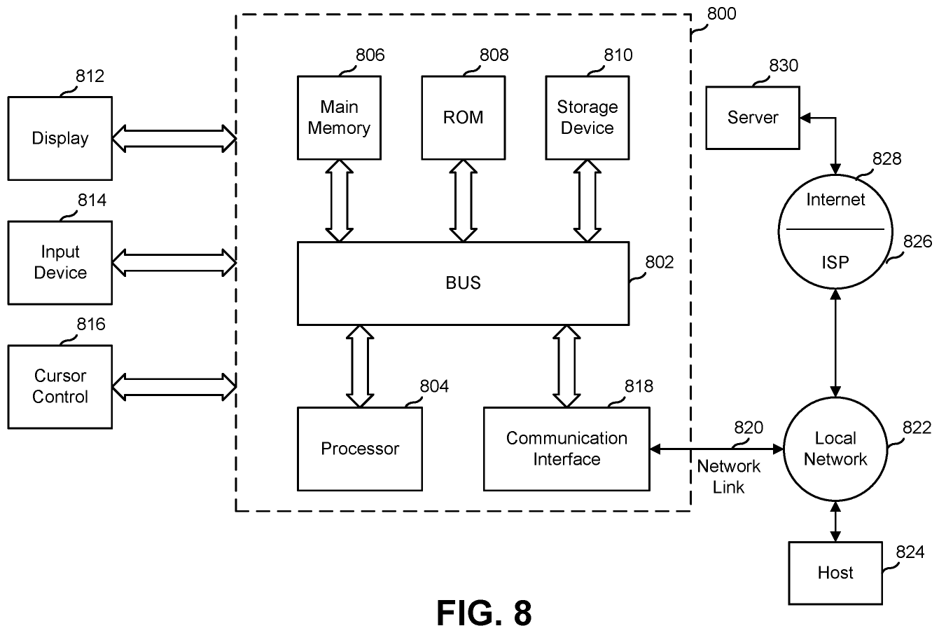

FIG. 8 is a block diagram that illustrates a computer system 800 upon which the computer systems of the systems described herein and/or data structures shown in FIG. 7 may be implemented. Computer system 800 includes a bus 802 or other communication mechanism for communicating information, and a processor 804 coupled with bus 802 for processing information. Processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 may also be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a computer monitor, for displaying information to a computer user. An input device 814, including alphanumeric and other keys, is coupled to bus 802 for communicating information and command selections to processor 804. Another type of user input device is a cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a network connection. A modem or network interface local to computer system 800 can receive the data. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be a network card, a modem, a cable modem, or a satellite modem to provide a data communication connection to a corresponding type of telephone line or communications line. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820, and communication interface 818. In the Internet example, a server 830 might transmit a requested code for an application program through the Internet 828, ISP 826, local network 822, and communication interface 818. The received code may be executed by processor 804 as it is received, and/or stored in storage device 810, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer system comprising:
a requester computer that requests data from a remote storage service using a data request; and
a router that receives the data request, analyzes the data request using a burden calculator, and selects a selected storage provider based on results of a burden calculation.

2. The computer system of claim 1, wherein the router is configured to route a modified data request to the selected storage provider, the modified data request corresponding to the data request and the selected storage provider.

3. The computer system of claim 1, wherein the remote storage service comprises cloud storage.

4. The computer system of claim 3, wherein the cloud storage is configured to store data in data units and a data unit of the data units comprises one or more of an object, a data record, a file, a data block, a blob, and/or fixed length data field.

5. The computer system of claim 1, wherein the remote storage service is storage accessible via one or more of a predetermined network interface, an application programming interface (API), and/or a network protocol.

6. The computer system of claim 1, wherein the burden calculator determines a plurality of component burdens, at least one of which comprises egress fees, quota limits, data at rest charges, availability metrics, latency metrics, network location metrics, reliability metrics, and/or geographic region indicators.

7. The computer system of claim 6, wherein at least one component burden of the plurality of component burdens comprises a customer preference measure representing a positive customer preference and/or a negative customer preference as to one or more particular storage provider.

8. The computer system of claim 6, wherein at least one component burden of the plurality of component burdens is adjusted to reflect a customer preference measure representing a positive customer preference and/or a negative customer preference as to one or more particular storage provider.

9. The computer system of claim 6, wherein the plurality of component burdens includes a jurisdictional component, wherein the jurisdictional component represents a burden and/or a constraint based on jurisdictional considerations of storing data in a particular jurisdiction.

10. The computer system of claim 9, wherein the jurisdictional component represents a measure of data privacy, data security, and/or governmental data access laws or rules in the particular jurisdiction.

11. The computer system of claim 1, wherein the burden calculator includes a rules-based module that applies rules to burden components and wherein the burden calculator includes a machine-learning module that determines burden components based on behavioral patterns and/or probabilistic predictions.

12. The computer system of claim 11, wherein the behavioral patterns include one or more of regular access peaks, adaptive latency measures, throughput measures, and/or data transfer size price adjustments.

13. A method, comprising:
receiving a data request at a data request router from a requesting computer, wherein the data request relates to associated data associated with the data request and wherein the data request represents a request to store the associated data, retrieve the associated data, modify the associated data, forward the associated data, and/or delete the associated data;
analyzing the data request using a burden calculator to determine a burden cost for each of a plurality of storage providers; and
selecting a selected storage provider from among the plurality of storage providers based on respective burden costs of storage providers of the plurality of storage providers calculated by the burden calculator.

14. The method of claim 13, further comprising:
routing the data request to the selected storage provider.

15. The method of claim 14, wherein routing the data request to the selected storage provider comprises sending a modified data request corresponding to the data request and the selected storage provider.

16. The method of claim 13, wherein the data request represents a request made to a remote storage service by the requesting computer, prior to selection of the selected storage provider.

17. The method of claim 13, wherein remote storage providers comprise cloud storage services and are configured to store data in data units and a data unit of the data units comprises one or more of an object, a data record, a file, a data block, a blob, and/or fixed length data field.

18. The method of claim 13, wherein the burden cost comprises a plurality of component burdens, at least one of which comprises egress fees, quota limits, data at rest charges, availability metrics, latency metrics, network location metrics, reliability metrics, and/or geographic region indicators.

19. The method of claim 18, wherein the plurality of component burdens includes a jurisdictional component, wherein the jurisdictional component represents a burden and/or a constraint based on jurisdictional considerations of storing data in a particular jurisdiction.

20. The method of claim 19, wherein the jurisdictional component represents a measure of data privacy, data security, and/or governmental data access laws or rules in the particular jurisdiction.

21. The method of claim 13, further comprising:
determining burden components using a rules-based module to apply rules to burden components; and
determining, using a machine-learning module, additional burden components based on behavioral patterns and/or probabilistic predictions.

22. A non-transitory computer-readable storage medium storing instructions, which when executed by at least one processor of a computer system, causes the computer system to carry out the method of claim 13.

23. A computer system comprising:
one or more processors; and
a storage medium storing instructions, which when executed by the one or more processors, cause the computer system to implement the method of claim 13.
